(19) United States
(12) Patent Application Publication
(10) Pub. No.: US 2019/0187108 A1
(43) Pub. Date: Jun. 20, 2019

(54) REMOVAL OF POLAR COMPOUNDS FROM A GAS SAMPLE

(71) Applicants: Svenja Erdmann, Isernhagen KB (DE); Brian Ochoa, Hannover (DE)

(72) Inventors: Svenja Erdmann, Isernhagen KB (DE); Brian Ochoa, Hannover (DE)

(73) Assignee: Baker Hughes, a GE company, LLC, Houston, TX (US)

(21) Appl. No.: 15/843,613

(22) Filed: Dec. 15, 2017

(51) Int. Cl. G01N 30/14; G01N 30/60; G01N 30/68

(52) U.S. Cl. CPC G01N 30/14; G01N 2030/025; G01N 30/68; G01N 30/60

(57) ABSTRACT

A method of analyzing formation fluids includes introducing a fluid sample into a chromatograph system, passing the fluid sample through a pre-column including a polar column member and a apolar column member in a first flow direction, separating polar constituents from the fluid sample in the pre-column forming an analytical fluid, passing the analytical fluid through a main column of the chromatograph system, and analyzing the analytical fluid in the main column.

### BACKGROUND

In the resource exploration and recovery industry, formation fluids are sampled at various phases of exploration, production, and other stages. For example, fluid logging is employed to determine constituents of fluid or formation fluids in a borehole. In many cases, the fluid is passed through a gas chromatograph for analysis. Contaminants, which may, for example, take the form of polar contaminants such as alcohols, ketones, and the like may bias or negatively affect fluid analysis. Therefore, the art would be open to systems and methods for removing contaminants from formation fluids.

### SUMMARY

Disclosed is a method of analyzing formation fluids including introducing a fluid sample into a chromatograph system, passing the fluid sample through a pre-column including a polar column member and a apolar column member in a first flow direction, separating polar constituents from the fluid sample in the pre-column forming an analytical fluid, passing the analytical fluid through a main column of the chromatograph system, and analyzing the analytical fluid in the main column.

Also disclosed is a fluid analyzer system including a sample input system and a pre-column system fluidically connected to a carrier gas control unit. The pre-column system includes a polar column member and an apolar column member. The pre-column system includes an inlet and an outlet. A main column has an inlet portion fluidically connected to the pre-column system and an outlet portion. A detector is fluidically connected to the outlet portion of the main column.

### BRIEF DESCRIPTION OF THE DRAWINGS

The following descriptions should not be considered limiting in any way. With reference to the accompanying drawings, like elements are numbered alike:

FIG. 1 depicts a fluid analyzer system in a first or pass through mode, in accordance with an aspect of an exemplary embodiment;

FIG. 2 depicts the fluid analyzer system of FIG. 1, in a second or analytical mode, in accordance with an aspect of an exemplary embodiment; and

FIG. 3 depicts the fluid analyzer system of FIG. 2, in a third or backflush mode, in accordance with an aspect of an exemplary embodiment.

### DETAILED DESCRIPTION

A detailed description of one or more embodiments of the disclosed apparatus and method are presented herein by way of exemplification and not limitation with reference to the Figures.

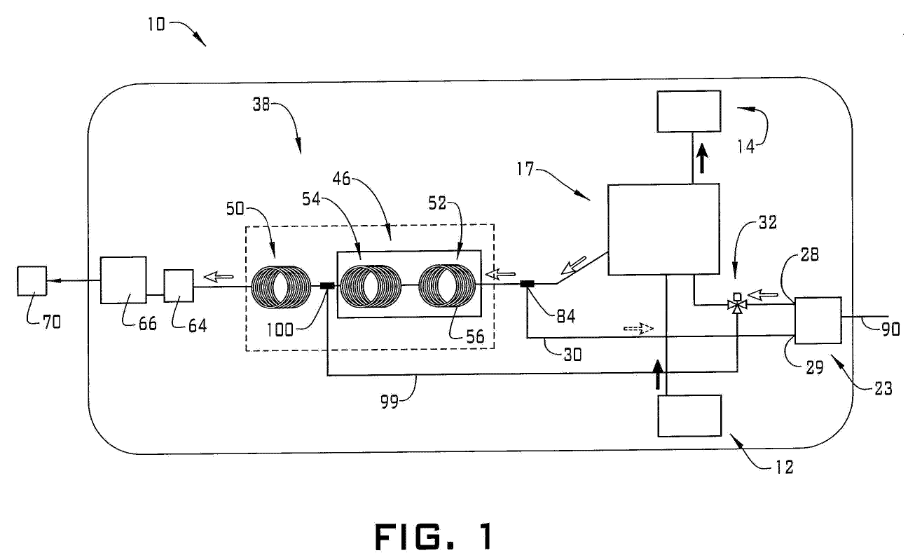

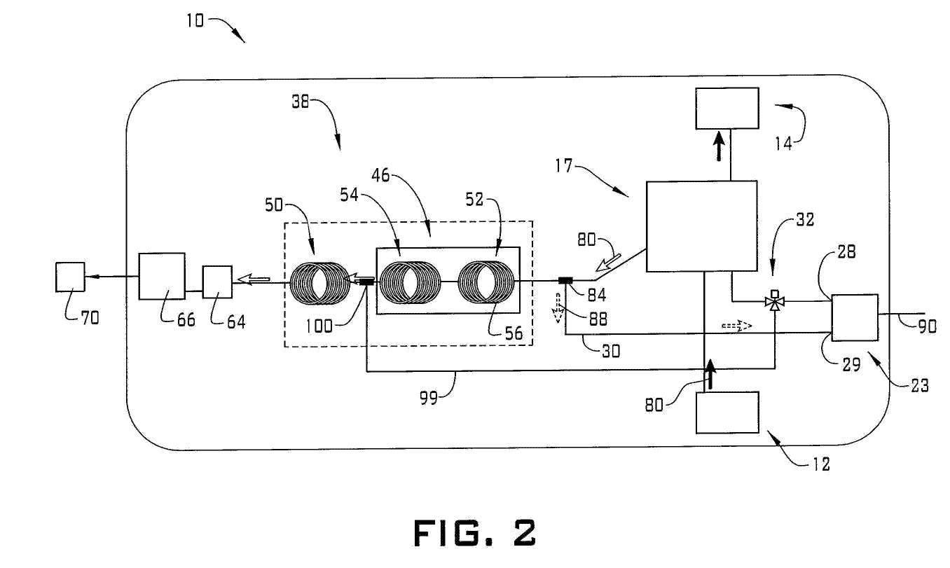

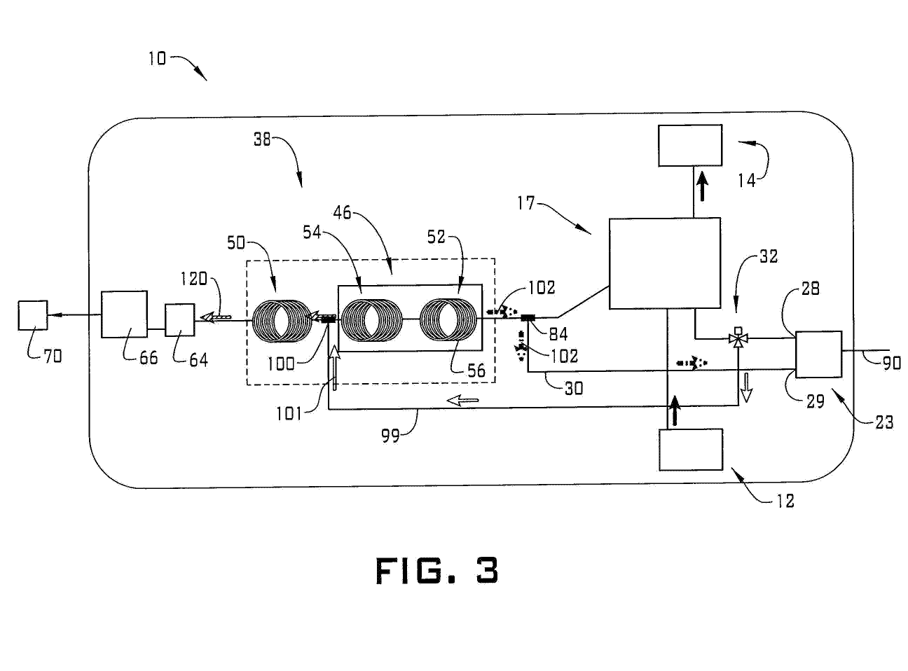

With initial reference to FIG. 1, a fluid analyzer system shown in the form of a chromatograph system is indicated generally at 10. Fluid analyzer system 10 includes a Fluid sample input system 12 and a sample output 14. Fluid sample input system 12 may take on a variety of forms that promote introduction of a fluid sample, such as, for example, mud gas, to a carrier gas. Fluid sample input system 12 and sample output 14 are fluidically connected to an injection unit 17. Injection unit 17 may be arranged in a first or pass through mode (FIG. 1) a second or analytical mode (FIG. 2), and a backflush mode (FIG. 3). At this point, it should be understood that the term “fluid” describes liquids, gases and/or mixtures thereof.

Fluid analyzer system 10 also includes a carrier gas control unit 23 that may include a carrier gas supply 28 and a vent line 29. Fluid analyzer 10 may also include a split line 30 that is connected to carrier gas control unit through a valve 32. In the first mode, a sample may pass from Fluid sample input system 12 through a sample loop (not separately labeled) and out through sample output 14 without being subjected to analysis.

In accordance with an exemplary aspect, fluid analyzer system 10 also includes a separation system 38 including a pre-column system 46 and a main column 50. The term “pre-column system” should be understood to describe that the pre-column of the fluid analyzer system 10 includes multiple columns. Further, it should be understood that the columns themselves may take on a variety of forms including capillary columns having a coating on an inner wall thereof. More specifically, pre-column system 46 includes an inlet (not separately labeled) leading to a first or polar column member 52 and a second or apolar column member 54 connected to an outlet (also not separately labeled) which leads to an inlet portion (also not separately labeled) of main column system 50. In this manner, pre-column system 46 should be understood to constitute a mixed column 56. It should also be understood that one of the first and second column members 52 and 54 may define a capillary column including an inner wall (not separately labeled) having a coating (also not separately labeled). The coating may take the form of polyethylene glycol. The terms first and second should not be understood to denote any sequential order of polar column member 52 and apolar column member 54. It should also be understood that the number and arrangement of columns may vary.

Fluid analyzer system 10 is further shown to include a flame ionization detector (FID) 64 fluidically connected to an outlet portion (not separately labeled) of main column 50 and a detector gas control unit 66 fluidically connected to FID 64. It should be understood that FID 64 may be replaced and/or augmented with other forms of detectors such as thermal conductivity detectors, mass spectrometers, pulsed discharge detectors, plasma emission detectors, photo ionization detectors, pulsed flame photometer detectors, a mass spectrometer, and the like. FID 64 provides an output identifying constituents of the analytical fluid. Specifically, FID 64 measures organic compounds entrained in a fluid sample exiting main column 50. Other detectors, if employed, may be configured to measure in-organic compounds. An output system 70 may be connected to detector gas control unit 66 and provides a visual output of various constituents of the fluid sample, as will be discussed herein.

In accordance with an exemplary aspect, injection unit 17 is placed in the second mode (FIG. 2) and a selected amount of fluid 80 is passed through a valve member 84 in a first flow direction to separation system 38. Another, residual portion of fluid 88 may be passed back to CCM 23 to a vent 90 in a second flow direction. Selected amount of fluid 80 flows to mixed column 56 through polar column member 52 and apolar column member 54. Mixed column 56 separates contaminants including polar and apolar constituents from fluid 80 forming a substantially contaminant free analytical fluid (not separately labeled) that is passed to main column 50. In main column 50, the substantially contaminant free analytical fluid is further separated into multiple constituents. In accordance with an exemplary aspect, the substantially contaminant free analytical fluid may contain one or more of hydrocarbons such as C1-C8 or above, non-hydrocarbons such as CO2, He, H2, N2, Ar and the like, and additional compounds such as alcohol, ketones, and/or other organic additives.

In accordance with an aspect of an exemplary embodiment, after a selected period of time, injection unit 17 is returned to the first mode and at a selected period of time, a backflush mode is initiated as shown in FIG. 3. In the backflush mode, a portion of the analytical fluid is passed to main column 50 and backflush gas, such as carrier gas indicated at 101, is passed through a backflush line 99 via a port 100 back through mixed column 56 to perform a back flush. The back flush cleans unwanted compounds (polar and apolar compounds) from mixed column 56. A fluid 102 laden with the unwanted compounds may then be passed through vent line 29 and vented through carrier gas control unit 23.

After passing through main column 50, an amount 120 of the analytical fluid is separated into multiple constituents is passed to FID 64 to be identified. An analysis of amount 120 of the analytical fluid is passed to output system 70 for review. At this point, it should be understood that the fluid analyzer of the exemplary embodiments employ a mixed column that selectively separates both polar and apolar compounds from a fluid sample prior to analysis. Removing these compounds ensures that the sample of fluid more accurately reflects virgin fluid, not substantially influenced by contaminants. In the context of mud gas logging this could mean that the virgin fluid is the formation fluid, and contaminants would be derived from the drilling mud system.

The exemplary embodiments may be employed in connection with mud logging operations. Mud logging and/or gas logging is a commonly applied service for the hydrocarbon industry and is referred to as the extraction and measurement of hydrocarbons in fluid (e.g., drilling mud), which may be dissolved, contained as bubbles or microbubbles, and/or otherwise present in the fluid. Measurements are conducted during a drilling operation with a Mass Spectrometer, a Gas Chromatograph, a combination thereof, an optical sensor, any other gas measurement device, or can be derived from fluid samples previously taken.

Set forth below are some embodiments of the foregoing disclosure:

Embodiment 1: A method of analyzing formation fluids comprising introducing a fluid sample into a chromatograph system, passing the fluid sample through a pre-column including a polar column member and an apolar column member in a first flow direction, separating polar constituents from the fluid sample in the pre-column forming an analytical fluid, passing the analytical fluid through a main column of the chromatograph system, and analyzing the analytical fluid in the main column.

Embodiment 2: The method of any prior embodiment, further comprising passing a backflush gas through the pre-column in a second flow direction after a selected period of time.

Embodiment 3: The method of any prior embodiment, wherein analyzing the analytical fluid includes passing the analytical fluid into a detector after passing through the main column.

Embodiment 4: The method of any prior embodiment, wherein passing the analytical fluid into the detector includes passing the analytical fluid into a flame ionization detector.

Embodiment 5: The method of any prior embodiment, further comprising: providing an output identifying constituents of the analytical fluid.

Embodiment 6: The method of any prior embodiment, wherein separating the at least one polar constituent includes separating at least one of an alcohol and a ketone.

Embodiment 7: The method of any prior embodiment, wherein passing the fluid sample through the pre-column include passing the fluid sample through a capillary column having an inner wall including a coating.

Embodiment 8: A fluid analyzer system comprising a fluid sample input system, a pre-column system fluidically connected to a carrier gas control unit, the pre-column system including a polar column member and an apolar column member, the pre-column system including an inlet and an outlet, a main column having an inlet portion fluidically connected to the pre-column system and an outlet portion, and a detector fluidically connected to the outlet portion of the main column.

Embodiment 9: The fluid analyzer system according to any prior embodiment, further comprising a detector gas control unit fluidically connected to the detector.

Embodiment 10: The fluid analyzer system according to any prior embodiment, further comprising a backflush line fluidically connected between the pre-column system and the main column, wherein the carrier gas control unit is selectively fluidically connected with the outlet of the pre-column system.

Embodiment 11: The fluid analyzer system according to any prior embodiment, wherein the detector is a flame ionization detector.

Embodiment 12: The fluid analyzer system according to any prior embodiment, wherein the pre-column system is configured to separate at least one polar constituent from a fluid sample received through the fluid sample input system.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of analyzing formation fluids comprising:
introducing a fluid sample into a chromatograph system;
passing the fluid sample through a pre-column including a polar column member and an apolar column member in a first flow direction;
separating at least one polar constituent from the fluid sample in the pre-column forming an analytical fluid;
passing the analytical fluid through a main column of the chromatograph system; and
analyzing the analytical fluid passing from the main column.

2. The method of claim 1, further comprising: passing a backflush gas through the pre-column in a second flow direction after a selected period of time.

3. The method of claim 1, wherein analyzing the analytical fluid includes passing the analytical fluid into a detector after passing through the main column.

4. The method of claim 3, wherein passing the analytical fluid into the detector includes passing the analytical fluid into a flame ionization detector.

5. The method of claim 1, further comprising: providing an output identifying constituents of the analytical fluid.

6. The method of claim 1, wherein separating the at least one polar constituent includes separating at least one of an alcohol and a ketone.

7. The method of claim 1, wherein passing the fluid sample through the pre-column include passing the fluid sample through a capillary column having an inner wall including a coating.

8. A fluid analyzer system comprising:
a fluid sample input system;
a pre-column system fluidically connected to a carrier gas control unit, the pre-column system including a polar column member and an apolar column member, the pre-column system including an inlet and an outlet;
a main column having an inlet portion fluidically connected to the pre-column system and an outlet portion; and
a detector fluidically connected to the outlet portion of the main column.

9. The fluid analyzer system according to claim 8, further comprising: a detector gas control unit fluidically connected to the detector.

10. The fluid analyzer system according to claim 8, further comprising: a backflush line fluidically connected between the pre-column system and the main column, the backflush line fluidically connecting the carrier gas control unit with the outlet of the pre-column system.

11. The fluid analyzer system according to claim 8, wherein the detector is a flame ionization detector.

12. The fluid analyzer system according to claim 8, wherein the pre-column system is configured to separate at least one polar constituent from a fluid sample received through the fluid sample input system.
